(19) United States
(12) Patent Application Publication
(10) Pub. No.: US 2004/0252669 A1
(43) Pub. Date: Dec. 16, 2004

(54) Common rate control method based on mobile transmit power

(76) Inventor: Patrick Hosein, San Diego, CA (US)

Correspondence Address: COATS & BENNETT, PLLC, P O BOX 5, RALEIGH, NC, 27602, US

(21) Appl. No.: 10/719,811

(22) Filed: Nov. 21, 2003

Related U.S. Application Data
(60) Provisional application No. 60/478,798, filed on Jun. 16, 2003.
(60) Provisional application No. 60/479,013, filed on Jun. 17, 2003.

(51) Int. Cl. H04B 7/216

(52) U.S. Cl. 370/342; 370/318

(57) ABSTRACT

A method and apparatus for implementing common rate control in a CDMA network that equalizes the transmit power of the mobile stations transmitting on the reverse link. Consequently, the transmission rate that is obtained by a given mobile station is dependent on the mobile station's current channel conditions on the reverse link channel.

### RELATED APPLICATIONS

This application claims priority under 35 U.S.C. § 119(e) from the following U.S. provisional applications: Application Ser. No. 60/478,798 filed on Jun. 16, 2003, Application Ser. No. 60/479,013 filed on Jun. 17, 2003, and the application of Tao Wu, Patrick Hosein, and Anthony C.K. Soong titled “Ericsson Generalized Common Rate Control Algorithm” filed Oct. 7, 2003 (serial number not assigned). These applications are incorporated in their entirety by reference herein.

### BACKGROUND OF THE INVENTION

In CDMA networks, the mobile stations share a reverse link channel and may transmit simultaneously. During transmission, each mobile station spreads its transmitted signal with a spreading code selected from a set of mutually orthogonal spreading codes. The base station is able to separate the signals received from the mobile stations by a correlation process. For example, if the base station desires to receive the signal transmitted by mobile station A, the base station correlates the received signal to the spreading code used by mobile station A to despread the signal from mobile station A. All other signals will appear as noise due to lack of correlation. The base station can despread signals from all other mobile stations in the same manner.

CDMA networks are interference-limited systems. Since all mobile stations operate at the same frequency, internal interference generated within the network plays a critical role in determining system capacity and signal quality. The transmit power from each mobile station contributes to the noise floor and needs to be controlled to limit interference while maintaining desired performance objectives, e.g., bit error rate (BER), frame error rate (FER), capacity, dropped-call rate, coverage, etc. If the noise floor is allowed to get too high, widespread outages may occur. An outage is considered to occur when the power required to maintain minimum signal quality standards is greater than the maximum transmit power of the mobile station.

Rate control is one technique used to control the transmit power of a mobile station in a CDMA network. In general, the power required to maintain a desired signal quality increases as the data rate for transmission increases, and decreases as the data rate for transmission decreases. When a mobile station is commanded to transmit at a given data rate, the mobile station will transmit at the minimum power level needed to maintain acceptable signal quality standards. Thus, one way of controlling the transmit power of a mobile station is to dynamically adjust the data transmission rate of the mobile stations depending on reverse link load.

One rate control technique is known as common rate control. With common rate control, all mobile stations that need to transmit data in the reverse link are allowed to do so. Each mobile station initially begins transmitting at a specified minimum rate (sometimes called the autonomous rate) and then, depending on load of the base stations in its active set, is allowed to vary its transmission rate. The base stations periodically estimate the reverse link load and compare the estimated reverse link load to a target load. If the load is below a target threshold, a base station commands the mobile stations in its cell to increase their transmission rate. Conversely, if the load is above the target threshold, a base station commands the mobile stations in their respective cells to decrease their transmission rate. In some cases, the base station may command the mobile stations to hold their current transmission rate.

One concern with common rate control is that it reduces system throughput compared to some other rate control methods. To maximize throughput, mobile stations operating under favorable conditions should allowed to transmit at the highest possible rates within the power limits of the mobile station. Common rate control reduces system throughput because mobile stations operating under favorable conditions will have their data transmission rate constrained by other mobile stations operating under less favorable conditions. To improve system throughput, mobile stations operating under advantageous conditions should be allowed to transmit at higher rates than mobile stations under less favorable conditions.

### SUMMARY OF THE INVENTION

The present invention relates to a method and apparatus for implementing common rate control in a reverse link channel in a CDMA network. In the various embodiments described herein, the mobile stations maintain an estimate of their current transmit power and use the transmit power estimate to compute a rate change probability. The rate change probability is the probability that the mobile station will change its transmit power in the next rate change interval. After computing the rate change probability, the mobile stations probabilistically change their data transmission rate, for example, by comparing the rate change probability to a randomly generated number.

In one embodiment of the invention, the base station transmits a target transmit power to the mobile stations. Each mobile station updates the transmit power based on periodic load indications from the base station. At a periodic rate change interval, each mobile station computes a rate change probability based on its current transmit power and the target transmit power from the base station, and probabilistically changes rate based on the rate change probability.

In an alternate embodiment, the mobile stations keep a load tracking value that serves as an estimate of the reverse link load. The load tracking value may, for example, be a weighted average of periodic load indications from the base station. The mobile stations compute a rate change probability as a function of the load tracking value and the current transmit power of the mobile station. In one embodiment, the mobile station determines a power dependent sliding window. If the current transmit power is inside the sliding window, the mobile station computes a first rate change probability. If the current transmit power is outside of the sliding window, the mobile station computes a second rate change probability.

The various embodiments attempt to equalize the transmit power of the mobile stations transmitting on the reverse link. Consequently, the transmission rate that is obtained by a given mobile station is dependent on the mobile station's current channel conditions on the reverse link channel. Mobile stations operating under favorable channel conditions will have a relatively higher transmission rates than mobile stations operating under less favorable channel conditions. For all mobile stations, the data transmission rate is proportional to the achievable rate of the mobile station. Proportionally fair rates are obtained when the ratio of the current data transmission rate to the maximum achievable rate is the same for all mobile stations.

### BRIEF DESCRIPTION OF THE DRAWINGS

FIG. 1 is a diagram of an exemplary wireless communication network according to one or more embodiments of the present invention.

FIG. 2 is a diagram of exemplary functional details for a radio base station according to the present invention.

FIG. 3 is a functional block diagram of an exemplary mobile station according to the present invention.

FIG. 4 is a graph illustrating reverse link load in a CDMA network implementing CRC according to one exemplary embodiment of the present invention.

FIG. 5 is a graph of the rate change probability as a function of a load tracking value y(n).

FIG. 6 illustrates a masking operation used in one embodiment of the present invention.

FIG. 7 is an exemplary graph of the expected transmit power versus the normalized transmit power for mobile stations performing the masking operation illustrated in FIG. 6.

FIG. 8 is a graph illustrating the impact of changes in variance of the load tracking value.

FIG. 9 is a graph illustrating the impact of changes in mean of the load tracking value.

### DETAILED DESCRIPTION OF THE INVENTION

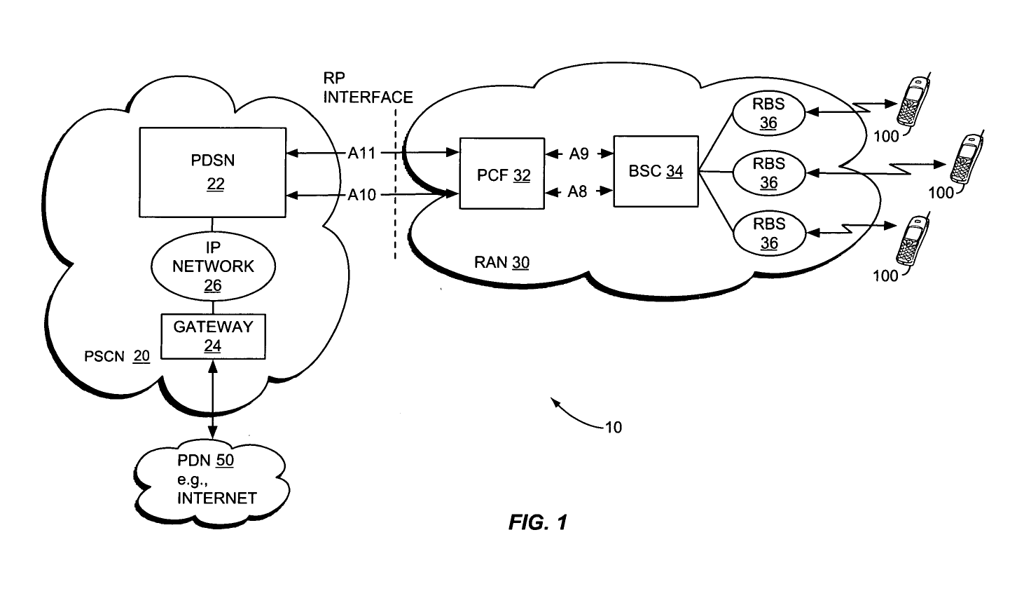

Turning to the drawings, FIG. 1 illustrates an exemplary wireless communication network 10 in which the present invention may be implemented. Network 10 may be any packet-switched communication network, for example, a cdma2000 wireless network according to the IS-2000/2001 families of standards. However, those skilled in the art will appreciate that the wireless communication network may be configured according to other standards, such as Wideband CDMA (WCDMA) standards, for example.

Network 10 includes a Packet-Switched Core Network (PSCN) 20 and a Radio Access Network (RAN) 30. The PSCN 20 provides connection to one or more Public Data Networks (PDNs) 50, such as the Internet. The PSCN 20 includes a packet data serving node (PDSN) 22, a gateway 24, and an IP network 26. The details of the PSCN 20 are not material to the present invention and, therefore, the PSCN 20 is not discussed further herein. The RAN 30 provides the radio interface between the mobile stations 100 and the PCSN 12. An exemplary RAN 30 comprises a Packet Control Function (PCF) 32, one or more Base Station Controllers (BSC) 34, and a plurality of Radio Base Stations (RBSs) 36. BSCs 34 connect to the RBSs 36 to the PCF 32. Mobile stations 100 communicate with the RBSs 36 via the air interface as defined by the appropriate network standards, such as the IS-2000 family of standards.

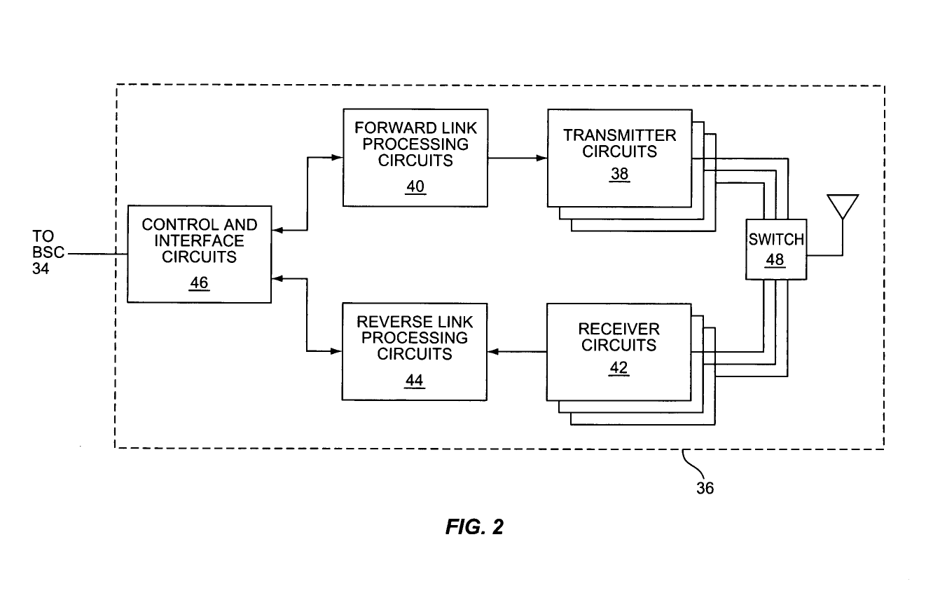

FIG. 2 illustrates a functional diagram of an exemplary RBS 36 according to one embodiment of the present invention. It will be appreciated that the present invention is not limited to the RBS architecture illustrated in FIG. 2, and that other RBS architectures are applicable to the present invention. The functional elements of FIG. 2 may be implemented in software, hardware, or some combination of both. For example, one or more of the functional elements in RBS 36 may be implemented as stored program instructions executed by one or more microprocessors or other logic circuits included in RBS 36.

As shown in FIG. 2, RBS 36 includes transmitter circuits 38, forward link signal processing circuits 40, receiver circuits 42, reverse link signals processing circuits 44, and control and interface circuits 46. The transmitter circuits 38 include the necessary RF circuits, such as modulators and power amplifiers, to transmit signals to mobile stations 100. The forward link signal processing circuits 40 process the signals being transmitted to the mobile stations 100. Forward link signal processing may include digital modulation, encoding, interleaving, encryption, and formatting. The receiver circuits 42 comprise the RF components, such as a receiver front end, necessary to receive signals form the mobile stations 100. Reverse link processing circuits 44 process the signals received from the mobile stations 100. Reverse link processing may include, for example, digital demodulation, decoding, de-interleaving, and decryption. Control and interface circuits 46 coordinate the operation of the RBS 36 and the mobile stations 100 within the applicable communication standards and interface the RBS 36 with the BSC 34. The forward link processing circuits 40, reverse link processing circuits 44, and control and interface circuits 46 may be integrated in a single processor, or may be implemented in multiple processors, hardware circuits, or a combination of processors and hardware circuits.

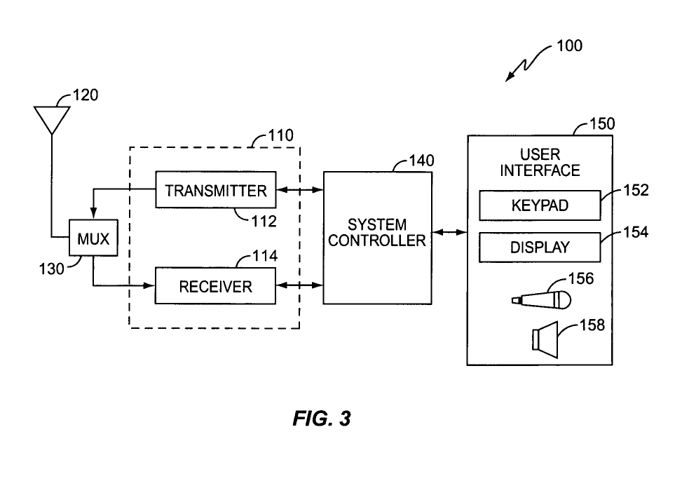

FIG. 3 is a functional block diagram of an exemplary mobile station 100 according to one embodiment of the present invention. As used herein, the term “mobile station” may include a cellular radiotelephone, a Personal Communications System (PCS) terminal that may combine a cellular radiotelephone with data processing, facsimile, and data communications capabilities; a Personal Data Assistant (PDA) that may include a pager, Web browser, radiotelephone, Internet/intranet access, organizer, calendar, and a conventional laptop and/or palmtop receiver or other appliances that include a radiotelephone transceiver.

Mobile station 100 includes a transceiver 110 connected to an antenna 120 via a multiplexer 130 as known in the art. Mobile station 100 further includes a system controller 140, and a user interface 150. Transceiver 110 includes a transmitter 112 and a receiver 114. Transceiver 110 may for example operate according to the cdma2000, WCDMA or UMTS standards. The present invention, however, is not limited to use with these standards and those skilled in the art will recognize the present invention may be extended or modified for other standards.

System controller 140 provides overall operational control for the mobile station 100 according to programs instructions stored in memory. System controller 140 may comprise a microprocessor or microcontroller and may be part of an application specific integrated circuit (ASIC). Memory represents the entire hierarchy of memory in a mobile station 100. Memory provides storage for data, operating system programs and application programs. Memory may be integrated with the system controller, or may be implemented in one or more discrete memory devices.

User interface 150 typically comprises a keypad 152, display 154, microphone 156 and/or speaker 158. Keypad 152 allows he operator to enter commands and select menu options while display 154 allows the operator to see menu options, entered commands, and other service information. Microphone 156 converts the operator's speech into electrical audio signals and speaker 158 converts audio signals into audible signals that can be heard by the operator. Those skilled in the art will appreciate that the user interface 150 may include additional features not illustrated by the exemplary embodiment.

The RBS 36 communicates with a plurality of mobile stations 100. In the exemplary embodiment, the mobile stations 100 transmit data to the RBS 36 over a rate controlled reverse link channel. The reverse link channel is preferably, but not necessarily, one designed for packet data. Multiple mobile stations 100 can transmit simultaneously on the reverse link channel and the RBS 36 distinguishes their respective signals by the spreading codes that are assigned to the mobile stations 100 at connection setup. When the RBS 36 despreads the signal received from a given mobile station 100, the transmission from all other mobile stations appear as noise. The quality of a signal received from a given mobile station 100 by the RBS 36 depends on thermal noise and the noise generated by all the other mobile stations 100. The total noise is dependent on the number of mobile stations 100 simultaneously transmitting on the reverse link and the transmit power of those mobile stations 100.

Signal to noise ratio (SNR) is one measure of the quality of the received signal. To maintain minimum signal quality standards, the mobile station 100 must transmit with enough power to maintain the SNR of the received signal above a predetermined level. If the noise floor (thermal noise+noise from other mobile stations 100) gets too high, the required transmit power to maintain the minimum signal quality standards, may exceed the maximum transmit power of the mobile station 100. This condition is referred to as an outage.

Common rate control (CRC) is one technique to control the amount of interference on a reverse link channel. The general aim of common rate control is to maintain reverse link load as close as possible to a desired target load so that the frequency of outages is maintained at an acceptable level, e.g. 1%, while utilizing the reverse link channel to the fullest extent possible. In most common rate control schemes, mobile stations 100 that have data to transmit are allowed to transmit. Initially, a mobile station 100 begins transmitting at a very low rate called the autonomous rate, which may for example be a rate of 9.6 kbs. After a mobile station 100 begins transmitting data, it is allowed to vary its transmission rate depending on reverse link load. The RBS 36 periodically estimates the reverse link load and transmits a load indication to all of the mobile stations 100 transmitting on the reverse link channel. Each mobile station 100 decides whether to increase or decrease its transmission rate based at least in part on the load indication from the RBS 36. Rate adjustment decisions by the mobile stations 100 will tend to follow the load indications from the RBS 36. If load at the RBS 36 increases above the target load, the mobile stations 100 in general will decrease their transmission rate to reduce the load. Conversely, if the load at the RBS 36 decreases below the target load, the mobile stations 100 in general will increase their transmission rate to increase the load and more efficiently use the reverse link channel. The rate adjustment decision of an individual mobile station 100, however, may not follow the load indication at a given time instant, since other factors may be evaluated in making rate change decisions.

CRC requires no rate feedback information from the mobile stations 100 to the RBS 36, and the RBS 36 broadcasts load indications to all mobile stations 100 on a common control channel. Consequently, CRC requires a low signaling overhead and is low in implementation complexity. However, CRC does not use the reverse link in the most efficient manner.

The present invention provides a method of CRC for a reverse link channel that increases system throughput as compared to conventional methods of CRC, and will result in proportionally fair data transmission rates for mobile stations transmitting on the reverse link channel. Proportionally fair rates are achieved when the ratio of the maximum achievable rate dᵢ(n) to the current data transmission rate rᵢ(n) is the same for all mobile stations. The ratio dᵢ(n)/rᵢ(n) should be the maximum that can be attained while maintaining the reverse link load at or below the maximum load L_{MAX}. The maximum achievable rate dᵢ(n) is given by:

$${d}_{i} ( n ) = {r}_{i} ( n ) \frac{{P}_{MAX}}{{p}_{i} ( n )} , \qquad Eq . 1$$

where P_{MAX} is the maximum power at which the mobile station can transmit, and pᵢ(n) is the transmit power of the mobile station 100 at the current rate rᵢ(n). Eq. 1 can be rewritten as:

$$\frac{{d}_{i} ( n )}{{r}_{i} ( n )} = \frac{{P}_{MAX}}{{p}_{i} ( n )} = K \qquad Eq . 2$$

Eq. 2 suggests that proportionally fair rates are obtained when the transmit power for all mobile stations 100 is equal to some constant value P_{MAX}/K. The CRC method according to the present invention attempts to equalize the transmit power for all mobile stations 100 to some target transmit power.

In one exemplary embodiment of the invention, equalization of mobile station transmit powers is achieved by transmitting a target transmit power P_{T}(n) from the RBS 36 to mobile stations 100 at connection setup or following a handoff. The target transmit power P_{T}(n) is based on a desired target load at the RBS 36 and represents the transmit power that should be maintained by each mobile station 100 transmitting on the reverse link channel. The RBS 36 begins with an initial estimate of P_{T}(n)=0 at startup. Periodically (e.g., once per frame), the RBS 36 estimates the reverse link load and broadcasts a quantized load indication to mobile stations 100 transmitting on the reverse link channel. The load indications, denoted b(n), may be transmitted to the mobile stations 100 over a common control channel. The mobile stations 100 adjust their data transmission rates as will be described in greater detail below. The RBS 36 additionally updates its estimate of the target transmit power P_{T}(n) based on the current estimated load L(n). If the estimated load L(n) at period n exceeds a maximum load L_{MAX}, the base station reduces the target transmit power P_{T}(n). Conversely, if the estimated load L(n) is lower than a minimum load L_{MIN}, the RBS 36 increases the target transmit power P_{T}(n).

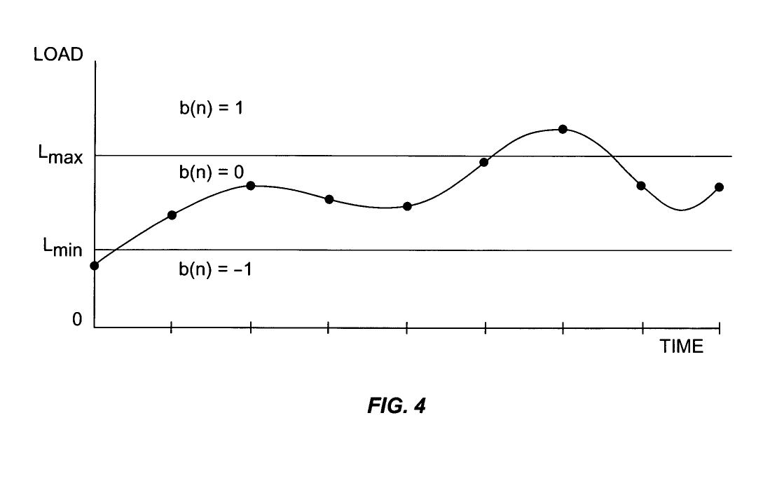

FIG. 4 is a graph illustrating reverse link load in a CDMA network implementing CRC in a reverse link packet data channel. In FIG. 4, the vertical axis represents the reverse link load, and the horizontal axis represents time. L_{MAX} is the maximum load beyond which the system is unstable and outages are likely to occur. L_{MIN} is the load below which the system is considered lightly loaded. The values L_{MAX} and L_{MIN} divide the range of possible load values into three regions. Table 1 below gives the load indications b(n) that may be transmitted by the RBS 36 to the mobile stations 100.

TABLE 1
Load Indications

| Estimated Load L(n) | Load Indication b(n) |
|---|---|
| L(n) > L_{MAX} | 1 |
| L_{MAX} > L(n) > L_{MIN} | 0 |
| L_{MIN} > L(n) | −1 |

The RBS 36 uses the load indications b(n) transmitted to the mobile stations 100 to update its estimate of P_{T}(n). Adjustment of the target transmit power P_{T}(n) may be according to:

P_{T}(n+1)=P_{T}(n)−αb(n), Eq. 3

where b(n) is the load indication transmitted to the mobile stations 100 at the nth rate change interval, and a is an adjustment factor that may be determined empirically.

The mobile stations 100 update their local estimate of P_{T}(n) based on the periodic load indications from the RBS 36, and use the local estimate of P_{T}(n) to dynamically adjust their data transmission rate. Assuming that the load indication from the RBS 36 is correctly received by the mobile station 100, the mobile station's estimate of P_{T}(n) should be the same as the RBS's estimate of P_{T}(n). If all mobile stations 100 transmit at the target transmit power, then the load at the RBS 36 will be at or near the target load.

Because the permissible data transmission rates for the mobile stations 100 are fixed, the mobile stations 100 cannot arbitrarily change their transmit power to equal a target transmit power P_{T}(n). Therefore, in one embodiment of the present invention, the mobile stations 100 transmitting on the reverse link channel probabilistically change their data transmission rates so that a total power adjustment for all of the mobile stations will approximate a desired adjustment. More particularly, the mobile station 100 computes a rate change probability q that represents the probability that it will change its data transmission rate in the next frame. Thus, some mobile stations 100 will change rate and some will not. The net effect will be the same as if all the mobile stations 100 adjusted their transmit power to the desired target transmit power P_{T}(n).

To implement the probabilistic rate change, each mobile station 100 keeps a filtered estimate of its own current transmit power, denoted pᵢ(n), and computes a rate change probability q based on its current transmit power pᵢ(n), the target transmit power P_{T}(n), and its projected transmit power pᵤ(n) or p_{d}(n) at the next lower or next higher data transmission rate. After updating the target transmit power P_{T}(n), the mobile station 100 compares the transmit power pᵢ(n) at its current transmission rate to the target transmit power P_{T}(n). If the current transmit power pᵢ(n) is greater than the target transmit power P_{T}(n), the mobile station 100 decreases its data transmission rate by one rate level with probability q_{d} of (pᵢ(n)−P_{T}(n))/(pᵢ(n)−p_{d} (n)). That is, the mobile station 100 computes a ratio R_{d} of a first difference pᵢ(n)−P_{T}(n) between its current transmit power pᵢ(n) and the target transmit power P_{T}(n), and a second difference pᵢ(n)−p_{d}(n) between its current transmit power pᵢ(n) and its projected power p_{d}(n) at the next lower rate level. The ratio R_{d} yields a downward rate change probability q_{d} If the ratio R_{d} exceeds 1, the mobile station 100 decreases its data transmission rate with probability q_{d}=1. Thus, the probability of a downward rate change when pᵢ(n)>P_{T}(n) is given by:

q_{d}=min{1,R_{d}} Eq. 4

If the current transmit pᵢ(n) is lower than the target transmit power P_{T}(n), the mobile station 100 increases its transmission rate by one rate level with probability qᵤ of (P_{T}(n)−pᵢ(n))/(pᵤ(n)−pᵢ(n)). That is, the mobile station 100 computes a ratio Rᵤ of a first difference P_{T}(n)−pᵢ(n) between the target transmit power P_{T}(n) and its current transmit power Pᵢ(n), and a second difference pᵤ(n)−pᵢ(n) between its projected power pᵤ(n) at the next higher rate level and its current transmit power Pᵢ(n). The ratio Rᵤ yields an upward rate change probability qᵤ. Thus, the rate change probability q computed by the mobile station 100 is the ratio of the permitted step change in power to the desired power adjustment. If the ratio exceeds 1, the mobile station 100 increases its data transmission rate with probability qᵤ=1. Thus, the probability of a upward rate change when pᵢ(n)<P_{T}(n) is given by:

qᵤ=min{1, Rᵤ) Eq. 5

In operation, the target transmit power P_{T}(n) will float up and down, depending upon load at the base station. If P_{T}(n) is too high, the average power transmitted by the mobile stations 100 will be too large and will result in the reverse link load exceeding the target load value. Consequently, the RBS 36 will reduce P_{T}(n), which causes a reduction in the average transmit powers of all mobile stations to reduce the reverse link load. The opposite is true if P_{T}(n) is too small. Therefore, the reverse link load will be maintained near capacity resulting in high throughput.

When a new user establishes a connection, the new user obtains the present value of P_{T}(n) from the RBS 36 and then tracks changes through the load indications broadcast by the RBD 36. Since the mobile station 100 starts at the autonomous rate, its initial transmit power will be typically much less than P_{T}(n). Consequently, the mobile station 100 will rapidly move up in rate, increasing the reverse link load. If the additional load of the new user causes the reverse link load to exceed the maximum load, the RBS 36 will reduce the target transmit power P_{T}(n). Therefore, the value of the target transmit power P_{T}(n) will be adjusted depending on the number of users.

As noted above, the present invention results in proportionally fair rates for all the users. All of the mobile stations 100 will transmit with approximately the same power. Thus, the transmission rate that is obtained by a given mobile station 100 will be dependent upon the current conditions of that mobile station's reverse link channel. Mobile stations 100 with favorable reverse link conditions will obtain a higher transmission rate than mobile stations 100 with less favorable reverse link conditions. The transmission rate that is obtained by all the mobile stations 100 will bear the same ratio to the maximum achievable rates of the mobile stations 100.

In a second embodiment of the present invention, the mobile stations keep a load tracking value that serves as an estimate of the reverse link load. The load tracking value may, for example, comprise a weighted average of periodic load indications b(n) from the RBS 36. In one exemplary embodiment of the invention, the load tracking value may be computed according to:

y(n)=αb(n)+(1−α)y(n−1), Eq. 6

where α is a smoothing factor. Eq. 6, in effect, computes a weighted average of successive load indications b(n) from the RBS 36 over a plurality of evaluation periods. The value of α, which is in the range of 0 to 1, determines the weight given to the load indication for the current evaluation period. When set to a value between 0 and 1, the smoothing factor α causes the weight of a periodic load indication b(n) for a current evaluation period to exponentially diminish in subsequent evaluation periods. When the smoothing factor α=1, the term (1−a)y(n−1) is 0 so that the load tracking value y(n) will always equal the load indication b(n) for the current evaluation period. When the smoothing factor α equals 0, the load tracking value y(n) does not change from one evaluation period to the next.

After updating the load tracking value y(n), the mobile stations 100 determine whether to change rate in the next evaluation period or frame. This rate change determination is made by mapping the load tracking value y(n) to a rate change probability q. The mobile stations 100 then probabilistically change their data transmission rate in the reverse link channel based on the rate change probability q. If X denotes the total received power on the reverse link channel at the RBS 36, and X_{T} denotes the received power at a target load L_{T}, then changing each mobile station's transmit power by the fraction

$$\frac{{X}_{T}}{X}$$

will approach the target load L_{T} at which the system should operate. Because the permissible data transmission rates for the mobile stations 100 are fixed, the mobile stations 100 cannot arbitrarily change their transmit power to equal a desired power. Therefore, in the second exemplary embodiment of the present invention, the mobile stations 100 transmitting on the reverse link channel probabilistically change their data transmission rates so that a total power adjustment for all of the mobile stations will approximate a desired adjustment.

If X_{MAX} denotes the maximum power at which the system can operate stably and X>X_{T}, the load tracking value y(n) maintained by each mobile station 100 can be estimated by:

$$y ( n ) = \frac{X - {X}_{T}}{{X}_{MAX} - {X}_{T}} \qquad Eq , 7$$

If

$$β ≡ \frac{{X}_{MAX}}{{X}_{T}} ,$$

then Eq. 7 can be rewritten to get:

$$\frac{X}{{X}_{T}} \approx 1 + y ( n ) ( β - 1 ) \qquad Eq . 8$$

Using Eq. 8, the mobile station 100 can compute an downward rate change probability q_{d} such that the expected value of its transmit power is equal to the desired power level. Assuming that each rate level corresponds to a 50% reduction in transmit power from the previous level, the rate change probability q_{d} when y(n)>0 may be computed according to:

$${p}_{i} ( n ) \frac{X}{{X}_{T}} = \frac{{p}_{i} ( n )}{1 + y ( n ) ( β - 1 )} = {q}_{d} \frac{{p}_{i} ( n )}{2} + ( 1 - {q}_{d} ) p ( n ) \qquad Eq . 9$$

Solving for q_{d}, we get:

$${q}_{d} = \frac{2 y ( n ) ( β - 1 )}{1 + y ( n ) ( β - 1 )} \qquad Eq . 10$$

In Eq. 10, the downward rate change probability is a function of the load tracking value y(n) and a power ratio

$$\frac{{X}_{MAX}}{{X}_{T}} .$$

Because there is a one-to-one relationship between received power at the RBS 36 and the reverse link load, the power ratio

$$\frac{{X}_{MAX}}{{X}_{T}}$$

is equivalent to the load ratio

$$\frac{{L}_{MAX}}{{L}_{T}} .$$

A similar analysis may be used to compute an upward rate change probability qᵤ as a function of the load tracking value The upward rate change probability may be given by:

$${q}_{u} ( n ) = \frac{- y ( n ) ( β - 1 )}{1 + y ( n ) ( β - 1 )} \qquad Eq . 11$$

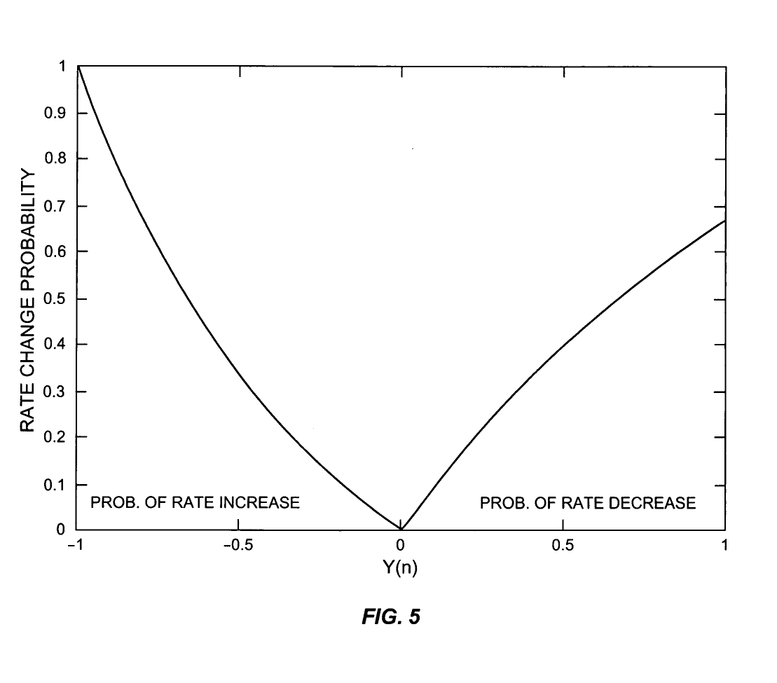

FIG. 5 is a graph of the rate change probability as a function of the load estimate y(n) where β=1.5.

In order to equalize the transmit powers of the mobile stations 100, the mobile stations 100 perform a masking operation before determining the rate change probability. The masking operation employs a power dependent sliding window or mask to ensure that the transmit powers of the mobile stations 100 converge towards a common transmit power, which is equivalent to the target transmit power in the first embodiment. In the second embodiment, the common power to which the mobile stations converge is not specified by the RBS 36, but instead is inherent to the masking operation. The common power is not fixed and will fluctuate as conditions change.

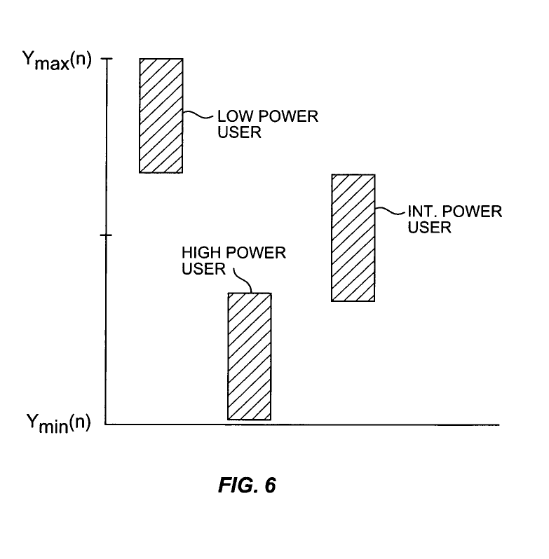

FIG. 6 illustrates the masking operation. As shown in FIG. 6, a sliding window is disposed over the load tracking range. The position of the sliding window is determined based on the mobile station's current transmit power pᵢ(n). If a given mobile station 100 is transmitting with low power, the sliding window will be near the top of the load tracking range. Conversely, if the mobile station 100 is currently transmitting with high power, the sliding window will be near the bottom of the low tracking range. For a mobile station 100 transmitting at a power level somewhere in the middle, the sliding window will be somewhere in the middle of the low tracking range.

When the mobile stations 100 receive the load indication b(n) from the RBS 36, the mobile stations 100 compute the load tracking value y(n) and compare the load tracking value y(n) to the sliding window. If the load tracking value y(n) is within the sliding window, the mobile stations 100 may set the rate change probability q to 0. If the load tracking value y(n) is outside of the sliding window, the mobile stations 100 may compute the rate change probability q as previously described. The masking operation is given by:

$$if \frac{- [ {p}_{i} ( n ) + ϵ ]}{{P}_{MAX}} \leq y ( n ) \leq w - \frac{[ {p}_{i} ( n ) + ϵ ]}{{P}_{MAX}} setq = 0 \qquad Eq . 12$$

In Eq. 12, w denotes the size of the sliding window and ε is a slowly varying offset that is used to accommodate changes in the traffic mix on the reverse link channel. The window size w may have a default value of 1. The window size may be fixed, or may be varied dynamically.

Assuming that ε is 0, mobile station 100 reduces its transmit power with some probability when y(n)>1−p(n)/P_{MAX}, and increases its transmit power with some other probability when y(n)<−p(n)/P_{MAX}. Denoting the probability distribution of y(n) as f_{y}, the expected value of a power change A as a function of the mobile station's current transmit power pᵢ(n) is given by:

$$\begin{matrix}E [ Δ ( p ( n ) ) ] = {\int }_{- 1}^{\frac{- p ( n )}{{p}_{max}}} {f}_{y} ( x ) ( {q}_{u} ( x ) 2 p ( n ) + ( 1 - {q}_{u} ( x ) ) p ( n ) ) ⅆ ( x ) + \\ {\int }_{\frac{- p ( n )}{{P}_{max}}}^{1 - \frac{p ( n )}{{p}_{max}}} {f}_{y} ( x ) p ( n ) ⅆ x + {\int }_{- \frac{p ( n )}{{P}_{max}}}^{1} {f}_{y} ( x ) \\ ( {q}_{d} ( x ) \frac{p ( n )}{2} + ( 1 - {q}_{d} ( x ) ) p ( n ) ) ⅆ x - p ( n ) \\ = {\int }_{- 1}^{\frac{p ( n )}{{p}_{max}}} {f}_{y} ( x ) {q}_{u} ( x ) p ( n ) ⅆ x - \\ {\int }_{- \frac{p ( n )}{{P}_{max}}}^{1} {f}_{y} ( x ) {q}_{d} ( x ) \frac{p ( n )}{2} ⅆ x .\end{matrix} \qquad Eq . 13$$

Note that E[Δ(0)]>0 while E[Δ(P_{MAX})<0. Furthermore, it is seen that the E[Δ(p(n))] is a monotonically decreasing function. This implies that there exists some power p^{*} to which the mobile stations 100 converge. When the mobile station's transmit power pᵢ(n)>p^{*,} then the expected value of the mobile station's transmit power decreases proportionally to pᵢ(n)−p*. On the other hand, if the mobile station's transmit power pᵢ(n)<p*, the expected value of the mobile station's transmit power increases proportionally to p*−pᵢ(n). As long as the distribution f_{y} is the same for all mobile stations 100, the power p^{*} will be the same for all mobile stations 100. Further, the convergence power p^{*} to which the mobile stations 100 converge shifts as the distribution f_{y} changes. If the distribution f_{y} shifts right (heavier loading), the convergence p^{*} shifts to the left and vice versa.

It is possible that the load generated when all the mobile stations 100 transmit at the power convergence power p^{*} will be outside the desired range. If the convergence power p^{*} is outside the operating range of the reverse link load, the average value of the load tracking value y(n) will be consistently either positive or negative. This condition may be detected by maintaining a first count C_{P} of the number of consecutive periods that y(n)>0 and a second count C_{N} of the number of times that y(n)<0. The appropriate counts may be reset when the y(n) changes sign. If the positive count C_{P} exceeds a positive threshold, then ε may be reduced by an amount δ_{P}. Conversely, if the negative count C_{N} exceeds a negative threshold, then ε may be increased by an amount δ_{N}. Adjusting ε will move the convergence power p^{*} so that it lies within the desired operating range of the reverse link load.

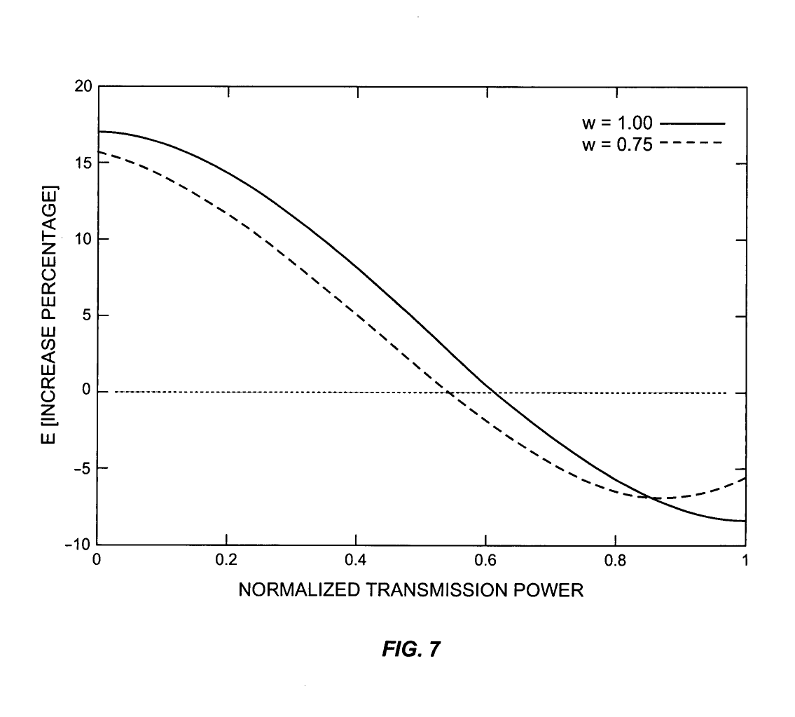

FIG. 7 is an exemplary graph of the expected transmit power versus the normalized transmit power for mobile stations 100 performing the masking operation as described above. The solid line represents a sliding window of size 1 and the dotted line represents a sliding window of size 0.75. FIG. 7 shows that the convergence power p^{*} shifts to the left as the window size decreases. Thus, adjusting the window size may be used as another method of adjusting the convergence power to be within a desired operating range of the reverse link load.

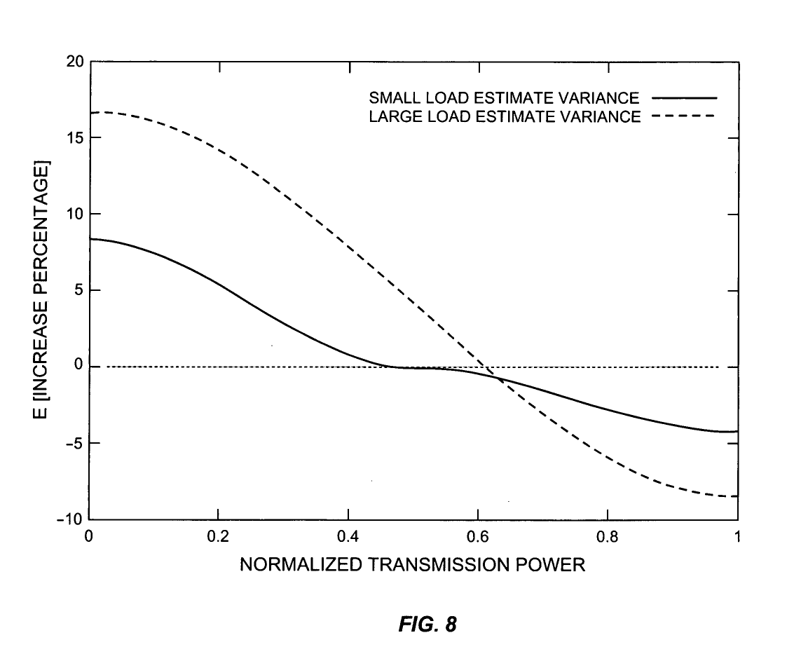

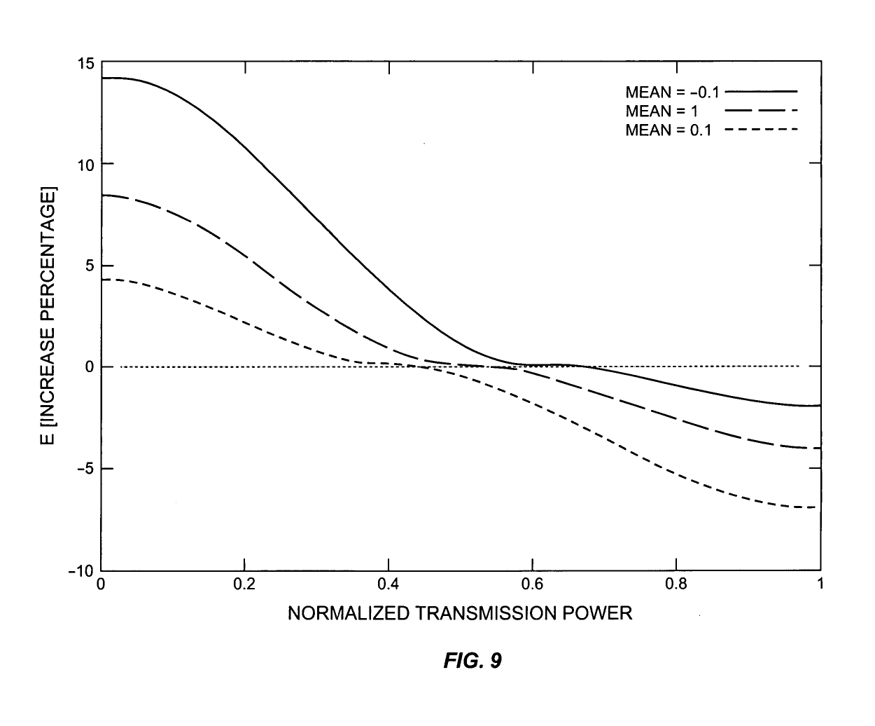

It can also be shown that the convergence power p^{*} is dependent on the mean and the variance of the load tracking value y(n). FIG. 8 is a graph illustrating the impact of changes in variance of the load tracking value y(n). In FIG. 9, the expected percent change in mobile transmit power is plotted versus normalized transmit power for triangular distribution of widths 2 and 1. FIG. 8 shows that reaction of the mobile station 100 decreases as the variance of the load tracking function y(n) decreases. FIG. 9 is a graph illustrating the impact of changes in the mean of the load tracking value y(n). In FIG. 9, the expected percent change in mobile transmit power is plotted versus normalized transmit power for a triangular distribution for y(n) of width 1 and means −0.1, 0, and 0.1. Note that the mean will not vary far from 0 due to the feedback mechanism. A mean of −0.1 indicates an under-loaded system, and a mean of 0.1 indicates an overloaded system. FIG. 8 shows that as the average load increases, the convergence power p^{*} moves to the left causing the mobile stations 100 to decrease their transmit power until the system becomes stable at a lower convergence power p^{*.}

What is claimed is:

1. A method of common rate control in a reverse link channel in a CDMA network, comprising:
estimating a reverse link load;
transmitting a periodic load indication indicative of the reverse link load on a common control channel to one or more mobile stations;
determining a desired target transmit power based on the estimated reverse link load; and
transmitting the target transmit power to at least one mobile station.

2. The method of claim 1 wherein transmitting the target transmit power to at least one mobile station comprises transmitting the target transmit power to the mobile station at connection setup.

3. The method of claim 1 wherein transmitting the target transmit power to at least one mobile station comprises transmitting the target transmit power to the mobile station following a handoff.

4. The method of claim 1 wherein transmitting the target transmit power to at least one mobile station comprises transmitting the target transmit power to a plurality of mobile stations over a common control channel.

5. The method of claim 1 wherein determining a desired target transmit power based on the estimated reverse link load comprises determining an estimated target transmit power for all mobile stations transmitting on the reverse link channel such that the expected total received power at the base station from all mobile stations is at a desired total received power level.

6. The method of claim 1 wherein determining a desired target transmit power comprises incrementally adjusting the target transmit power based on the periodic load indications.

7. The method of claim 1 wherein a load indication is transmitted periodically to the mobile stations at a predetermined rate change interval.

8. The method of claim 7 wherein the target transmit power is updated periodically.

9. The method of claim 8 wherein the target transmit power is updated at least once in each rate change interval.

10. A base station comprising:
receive circuits to receive signals on a reverse link channel from a plurality of mobile stations;
transmit circuits to transmit periodic load indications indicative of a reverse link load on the reverse link channel and a desired target transmit power on a forward link channel to mobile stations transmitting on the reverse link channel to control the transmission rate of the mobile stations on the reverse link channel; and
control circuits operative to:
estimate the reverse link load; and
determine the desired target transmit power based on the estimated reverse link load.

11. The base station of claim 10 wherein the target transmit power is transmitted to mobile stations at connection setup.

12. The base station of claim 10 wherein the target transmit power is transmitted to mobile stations following a handoff.

13. The base station of claim 10 wherein the target transmit power is transmitted to mobile stations periodically.

14. The base station of claim 10 wherein the control circuits determine the desired target transmit power based on the estimated reverse link load such that the expected total received power at the base station from all mobile stations is at a desired total received power level.

15. The base station of claim 10 wherein the control circuits determine the desired target transmit power by incrementally adjusting the target transmit power based on the periodic load indications.

16. The base station of claim 10 wherein the load indication is transmitted periodically to the mobile stations at a predetermined rate change interval.

17. The base station of claim 16 wherein the control circuit periodically updates the target transmit power

18. The base station of claim 17 wherein the control circuit updates the target transmit power at least once in each rate change interval.

19. A method of dynamically adjusting a data transmission rate of a mobile station, comprising:
determining a rate change probability as a function of a current transmit power of mobile station; and
selectively changing the data transmission rate of the mobile station based on the rate change probability.

20. The method of claim 19 wherein determining a rate change probability as a function of a current transmit power of mobile station comprises:
storing a target transmit power in the mobile station; and
computing a rate change probability as a function of the current transmit power of the mobile station and the target transmit power.

21. The method of claim 19 further comprising:
receiving periodic load indications from a base station; and
updating the target transmit power based on the periodic load indications from the base station.

22. The method of claim 20 wherein computing a rate change probability as a function of the current transmit power of the mobile station and the target transmit power comprises:
computing a first power differential between the current transmit power and the target transmit power;
computing a second power differential between the current transmit power and a maximum or minimum transmit power; and
determining a power differential ratio of the first and second power differentials; and
determining the rate change probability as a function of the power differential ratio.

23. The method of claim 22 wherein the rate change probability is equal to the power differential ratio.

24. The method of claim 22 wherein the rate change probability is the maximum of 1 and the power differential ratio.

25. The method of claim 20 further comprising receiving the target transmit power from the base station.

26. The method of claim 20 wherein the target transmit power is received by the mobile station during connection setup.

27. The method of claim 20 wherein the target transmit power is received by the mobile station following a handoff.

28. The method of claim 20 wherein the target transmit power is received by the mobile station over a common control channel.

29. The method of claim 19 wherein determining a rate change probability as a function of a current transmit power of mobile station comprises:
computing a load tracking value representative of the reverse link load at the mobile station;
computing a first rate change probability if the load tracking value is within a defined range that is dependent on the current transmit power of the mobile station; and
computing a second rate change probability if the load tracking value is outside the defined range.

30. The method of claim 29 wherein the first rate change probability is set to 0 when the load tracking value is within the defined range.

31. The method of claim 29 wherein the second rate change probability varies depending on the distance of the load tracking value from a reference value.

32. The method of claim 31 wherein the rate change probability varies linearly with distance of the load tracking value from the reference value.

33. The method of claim 31 wherein the rate change probability varies non-linearly with distance of the load tracking value from the reference value.

34. A mobile station comprising:
a receiver for receiving periodic load indications from a base station;
a transmitter for transmitting signals to the base station at a variable data transmission rate;
a controller to vary the data transmission rate of the mobile station, said controller operative to:
determine a rate change probability as a function of a current transmit power of the mobile station; and
selectively change the data transmission rate of the mobile station based on the rate change probability.

35. The mobile station of claim 34 wherein the controller computes the rate change probability as a function the current transmit power of the mobile station and a target transmit power.

36. The mobile station of claim 35 wherein the controller further updates the target transmit power based on periodic load indications from the base station.

37. The mobile station of claim 35 wherein controller computes the rate change probability by:
computing a first power differential between the current transmit power and the target transmit power;
computing a second power differential between the current transmit power and a maximum or minimum transmit power; and
determining a power differential ratio of the first and second power differentials; and
determining the rate change probability as a function of the power differential ratio.

38. The mobile station of claim 37 wherein the rate change probability is equal to the power differential ratio.

39. The mobile station of claim 37 wherein the rate change probability is the maximum of 1 and the power differential ratio.

40. The mobile station of claim 35 further wherein the mobile station receives the target transmit power from the base station.

41. The mobile station of claim 35 wherein the mobile station receives the target transmit power during connection setup.

42. The mobile station of claim 35 wherein the mobile station receives the target transmit power following a handoff.

43. The mobile station of claim 35 wherein the mobile station receives the target transmit power over a common control channel.

44. The mobile station of claim 34 wherein the controller determines the rate change probability by:
computing a load tracking value representative of the reverse link load at the mobile station;
computing a first rate change probability if the load tracking value is within a defined range that is dependent on the current transmit power of the mobile station; and
computing a second rate change probability if the load tracking value is outside the defined range.

45. The mobile station of claim 44 wherein the controller sets the first rate change probability to 0 when the load tracking value is within the defined range.

46. The mobile station of claim 44 wherein the controller computes the second rate change probability as a function of the distance of the load tracking value from a reference value.

47. The mobile station of claim 46 wherein the rate change probability varies linearly with distance of the load tracking value from the reference value.

48. The mobile station of claim 46 wherein the rate change probability varies non-linearly with distance of the load tracking value from the reference value.
